(19) United States
(12) Patent Application Publication
(10) Pub. No.: US 2020/0198936 A1
(43) Pub. Date: Jun. 25, 2020

(54) SECURITY DETECTION METHOD AND DEVICE FOR ESCALATOR

(71) Applicant: JALAND TECHNOLOGY CO., LIMITED, KL (HK)

(72) Inventor: Weizhong Lin, KL (HK)

(21) Appl. No.: 16/239,563

(22) Filed: Jan. 4, 2019

(30) Foreign Application Priority Data
Dec. 20, 2018 (CN) 201811562962.0

(51) Int. Cl. B66B 29/00; B66B 23/12; B66B 21/04; B66B 23/24; B66B 23/04

(52) U.S. Cl. CPC B66B 29/005; B66B 23/12; B66B 23/04; B66B 23/24; B66B 21/04

(57) ABSTRACT

A security detection device for escalator, comprising a detecting circuit disposed on the inner side of the guardrails and for judging passengers, and the detecting circuit comprises a plurality of transmitting tubes disposed on the inner side of the guardrail, and a plurality of receiving tubes disposed on the inner side of the other guardrail, and the positions of the receiving tubes are one-to-one corresponding to the positions of the transmitting tubes; when light of the transmitting tubes is blocked by the passengers, and the receiving tubes generate an electrical signal, and after being recognized by the matrix recognition circuit, the signal is combined to form an image signal; after the detection interval time, receive a new image signal and compare it with the previous image signal, and when the difference exceeds the setting value, output a control signal to stop the motor, thereby stopping the moving of steps.

### CROSS REFERENCE TO RELATED APPLICATION

The present application claims the priority to Chinese application with application No. CN201811562962.0, filed on Dec. 20, 2018. The contents of CN201811562962.0 are all hereby incorporated by reference.

### FIELD OF THE INVENTION

The present application relates to the field of escalator security detection, and more particularly, to a security detection method and device for escalator.

### BACKGROUND OF THE INVENTION

Escalators of prior art often have accidents. One of the accidents is when there are few people on the escalator, the accident happen to the elderly or children, or other people with disabilities for some reason, for example, they stand unsteadily, or does not adapt to the moving speed of the escalator. After the accident, the escalator continues to operate, and it is very likely to cause secondary damage to the people.

Therefore, it is necessary to improve the intelligence of an escalator to protect special populations.

### SUMMARY OF THE INVENTION

The embodiments of the present application provide a security detection method and device for escalator.

The technical solution adopted by the present application is: a security detection method for escalator, wherein, the escalator comprises a truss, and steps slidably disposed on the truss and driven by a motor through a power mechanism, and both sides of the steps are provided with guardrails, and the inner side of the guardrail is provided with a plurality of transmitting tubes, and a plurality of receiving tubes which are one-to-one corresponding to the transmitting tubes; the security detection method for the escalator comprises the following steps:

Step S10: starting the escalator;

Step S20: detecting a current image signal formed on the receiving tubes and caused by a blockage of a first current passengers, and saving it as a first image signal;

Step S30: receiving a second image signal of a second current passengers after a detection interval time, and comparing the second image signal with the first image signal, and if the difference between the two image signals exceeds a setting value for image, proceeding to step S40, otherwise, replacing the first image signal with the second image signal, and proceeding to the step S20;

Step S40: outputting a stopping signal;

Wherein the method further comprises the following step between the step S20 and the step S30:

Step S25: detecting a sound made by passengers by sound pick-ups disposed in the guardrails, and if a received sound signal is greater than a setting value for sound, or a waveform of the sound signal and a setting waveform reach a setting similarity, proceeding to the step S40, otherwise, proceeding to the step S30; wherein the setting waveform refers to a signal set formed by waveform information of a sound wave signal for rescue made by a plurality of passengers.

Further, the method further comprises a step S15 between the step S10 and the step S20:

Step S15: detecting whether a self-learning button is triggered, and if the self-learning button is triggered, proceeding to a self-learning step: when testers take the escalator, a generated image signal and a deformation value thereof are normal values, and calculating an average of signals generated by multiple testers, and saving it as the setting value for image, and repeating the step in a setting time period; if the self-learning button is not triggered, proceeding to the step S20.

A security detection method for escalator, wherein, the escalator comprises a truss, and steps slidably disposed on the truss and driven by a motor through a power mechanism, and both sides of the steps are provided with guardrails, and the inner side of the guardrail is provided with sound pick-ups for detecting a sound made by passengers; the security detection method for the escalator comprises the following steps:

Step A10: starting the escalator;

Step A15: detecting a first sound made by a first current passengers by the sound pick-ups and storing it as a first sound signal;

Step A20: detecting a second sound signal after a setting time interval, and if a changing amount between the second sound signal and the first sound signal exceeds a setting value, proceeding to step A30; otherwise, proceed to the next step;

Step A25: proceeding to the next step when a received current sound signal is greater than a setting value or when a waveform of the sound signal and a setting waveform reach a setting similarity; otherwise, proceeding to the step A15; wherein the setting waveform refers to a signal set formed by waveform information of a sound wave signal for rescue made by a plurality of passengers;

Step A30: outputting a stopping signal;

Or,

The escalator comprises a truss, and steps slidably disposed on the truss and driven by a motor through a power mechanism, and both sides of the steps are provided with guardrails, and the inner side of the guardrail is provided with at least one set of sound pick-ups, and each set of sound pick-ups comprises a real-time sound pick-up and a reference sound pick-up which are installed at a same position, and the reference sound pick-up is connected to a microcontroller through an audio time delayer; the sound pick-ups are disposed in sound pick-up holes disposed on the inner side of the guardrail at intervals; a sound signal collected by the reference sound pick-up is transmitted to the microcontroller through the audio time delayer, and is saved as a reference sound pick-up signal, and a real-time sound signal collected by the real-time sound pick-up is transmitted to the microcontroller, and is compared with the reference sound pick-up signal, and when a changing amount between the real-time sound signal and the reference sound pick-up signal exceeds a setting value, and the time that the changing amount exceeds the setting value continuously reaches a setting number of times, output a stopping signal.

A security detection device for escalator, wherein the escalator comprises a truss, and steps slidably disposed on the truss and driven by a motor through a power mechanism, and both sides of the steps are provided with guardrails; and the security detection device comprises a detecting circuit disposed on the inner side of the guardrails and for judging passengers, and the detecting circuit comprises a plurality of transmitting tubes disposed on the inner side of the guardrail, and a plurality of receiving tubes disposed on the inner side of the other guardrail, and the positions of the receiving tubes are one-to-one corresponding to the positions of the transmitting tubes; the security detection device further comprises a microcontroller, and a matrix recognition circuit, a speed sensor, and a motor controlling receiving end which are electrically connected to the microcontroller; when the light of the transmitting tubes is blocked by the passengers, and the receiving tubes that have not received the light change to generate an electrical signal, and after being recognized by the matrix recognition circuit, the signal is combined to form an image signal which is saved in the microcontroller; and then divide a distance of the steps in the moving direction by a movement speed of the steps detected by the speed sensor, to get a detection interval time of the receiving tube; after the detection interval time, the microcontroller receives a new image signal and compares it with the previous image signal, and when the difference between the two image signals exceeds the setting value, output a control signal to the motor controlling receiving end to stop the motor, thereby stopping the moving of the steps; the security detection device further comprises a mounting box for accommodating the microcontroller, and the mounting box is further provided with a control button electrically connected to the microcontroller, and the control button comprises a switch button and a self-learning button.

Further, the transmitting tubes are distributed in a matrix; a spacing between two adjacent transmitting tubes in a moving direction of the steps is 50-100 mm, and a spacing between the two adjacent transmitting tubes perpendicular to the moving direction of the steps is 100-200 mm.

Further, the transmitting tube is an infrared transmitting tube, and the receiving tube is an infrared receiving tube.

Further, the guardrail comprises two fixed guardrails respectively disposed at an upper entrance and a lower entrance, and a movable guardrail disposed between the two fixed guardrails, and the movable guardrail is a reciprocating coaming plate that could be moved cyclically relative to the truss, and a movement speed of the coaming plate is the same as the movement speed of the steps.

Further, an input end of the microcontroller is electrically connected to at least one set of sound pick-ups, and each set of sound pick-ups comprises a real-time sound pick-up and a reference sound pick-up which are installed at a same position, and the reference sound pick-up is connected to the microcontroller through an audio time delayer; the sound pick-ups are disposed in the sound pick-up holes disposed on the inner side of the guardrail at intervals; gratings are arranged above the guardrail to remind passengers not to extend out of the guardrail; wherein a sound signal collected by the reference sound pick-up is transmitted to the microcontroller through the audio time delayer, and is saved as a reference sound pick-up signal, and a real-time sound signal collected by the real-time sound pick-up is transmitted to the microcontroller, and is compared with the reference sound pick-up signal, and when a changing amount between the real-time sound signal and the reference sound pick-up signal exceeds a setting value, and the time that the changing amount exceeds the setting value continuously reaches a setting number of times, output a stopping signal.

Compared with the prior art, the beneficial effects of the embodiments of the present application are: the security detection device for escalator of the present application has a detecting circuit for judging the passengers disposed on the inner side of the guardrail, and when the difference of the image data detected at two different times exceeds a setting range, determine that the passenger has an accident, and then stop the operation of the escalator and ensure the safety of the passengers on the ladders. In addition, the guardrail is provided with a reciprocating coaming plate that could be moved cyclically, and the movement speed of the coaming plate is the same as the movement speed of the step, which further improves the safety of the escalator and could better protect the safety of the passengers on the ladders.

The above description is only an overview of the technical solutions of the present application, and in order to clearly understand the technical features to implement the technical solutions according to the content of the specification and in order to make the above content and other objects, features and advantages of the present application more apparent and obvious, the preferred embodiments will be described in detail below with reference to the accompanying drawings.

### BRIEF DESCRIPTION OF THE DRAWINGS

FIG. 1 is a flow chart of a safety detection method for an escalator according to an embodiment of the present application;

FIG. 2 is a flow chart of a safety detection method for an escalator according to another embodiment of the present application;

FIG. 3 is a stereogram of a safety detection device for an escalator according to an embodiment of the present application;

FIG. 4 is a side view of a safety detection device for an escalator according to another embodiment of the present application;

FIG. 5 is a schematic view of a guardrail and a sound pick-up hole of a safety detection device for an escalator according to another embodiment of the present application;

FIG. 6 is a circuit block diagram of a safety detection device for an escalator according to the present application.

Reference numbers

| | |
|---|---|
| 1- Escalator | 11- Step |
| 12- Guardrail | 121-Fixed guardrail |
| 122-Movable guardrail | 2-Security detection device |
| 21-Detecting circuit | 211-Transmitting tube |
| 212-Receiving tube | 22-Matrix recognition circuit |
| 23-Speed sensor | 24-Microcontroller |
| 25-Motor controlling receiving end | 26-Sound pick-up |
| 261-Real-time sound pick-up | 262-Reference sound pick-up |
| 27- Sound pick-up hole | |

### DESCRIPTION OF THE EMBODIMENTS

In order to more fully understand the technical content of the present application, the technical solutions of the present application are further described and illustrated below with reference with the embodiments, but are not limited thereto.

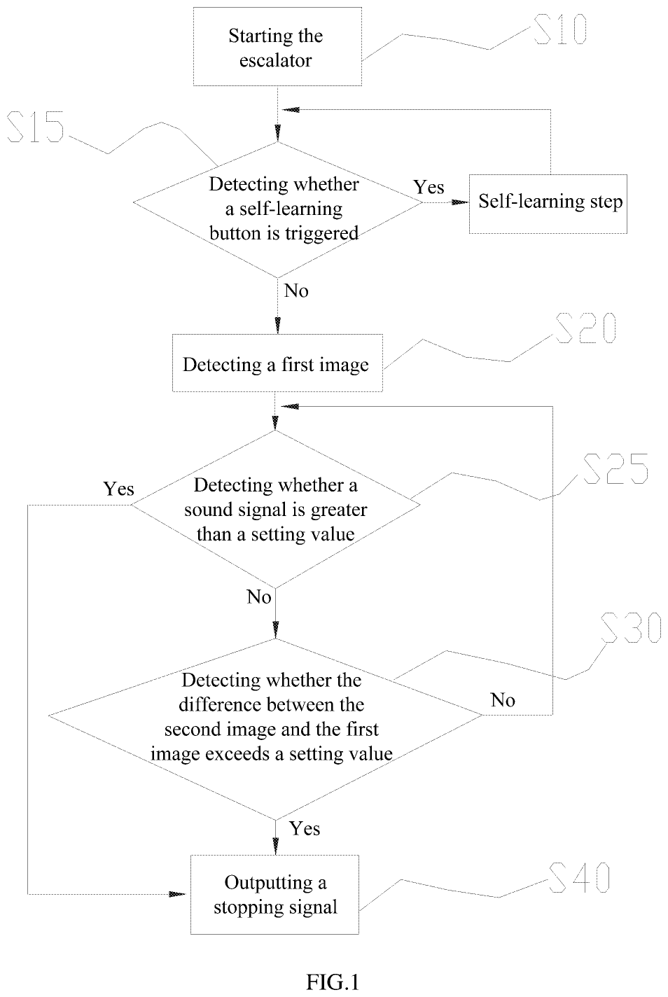

Please refer to FIG. 1, a security detection method for an escalator, comprising the following steps:

Step S10: starting the escalator;

Step S20: detecting a current image signal formed on receiving tubes and caused by the blockage of the current passengers on ladders, and saving it as a first image signal;

Step S30: receiving a second image signal of the current passengers on ladders after a detection interval time, and comparing the second image signal with the first image signal, and if the difference between the two image signals exceeds a setting value, proceed to a next step S40, otherwise, replace the first image signal with the second image signal, and proceed to the step S20;

Step S40: outputting a stopping signal.

More preferably, in the step S20:

The current passengers on ladders refer to a combination of people on the steps from the entrance of the escalator to the exit of the escalator; at the entrance of the escalator, there are new people entering, and at the exit of the escalator, there are people leaving, so the combination of people randomly and dynamically changes, therefore, the images formed by them also randomly change, and the normal difference values of the image signals caused by entering and leaving are summed as reference factors in the process of self-learning. When there are very few people entering the escalator, and when someone falls, the situation could be detected. When the people are intensive, the images formed by passengers adjacent to each other will be connected together, and when an individual people fall, the situation could not be detected, however, because there are many people, they could help each other and quickly press the stop button.

The method further comprises a step S25 between the step S20 and the step S30:

Step S25: detecting a sound made by the current passengers on ladders by sound pick-ups disposed in the guardrail, and if a received sound signal is greater than a setting value, or a waveform and a setting waveform reach a setting similarity, proceed to the step S40, otherwise, proceed to the step S30. Wherein, a specific sound signal (such as “Help”, “Need help”, etc.) could be set in advance, and control the escalator to stop once the passengers on ladders make such a specific sound. In addition, the sound pick-up is electrically connected to a buzzer, and when the sound pick-up receives the specific sound signal, the sound pick-up sends a signal to the buzzer to make an alarm to inform the surrounding people to get help.

The method further comprises a step S15 between the step S10 and the step S20:

Step S15: detecting whether a self-learning button is triggered, and if the self-learning button is triggered, proceed to a self-learning step: when testers take the escalator, the generated image signal and the deformation value thereof are normal values, and calculate an average of the signals generated by multiple testers, and save it as a setting value, and repeat this step in a setting time period. If the self-learning button is not triggered, proceed to the step S20.

In other embodiments, it could be determined whether a passenger on ladders has an accident by detecting whether the movement speed of the image formed on the receiving tubes and caused by the blockage of the current passengers on ladders is close to the movement speed of the steps. The specific method is as follows:

Step one: starting the escalator;

Step two: detecting whether the density value of the image formed on the receiving tubes and caused by the blockage of the passengers on ladders is lower than a preset density value, and if yes, proceed to the next step, otherwise detect the image again;

Step three: detecting whether the difference between the movement speed of the image and the movement speed of the steps exceeds a setting value, and if yes, determine that a passenger on ladders has an accident, and output a control signal to the motor controlling receiving end to stop the motor and to sop the moving of the steps; otherwise, repeat the step two.

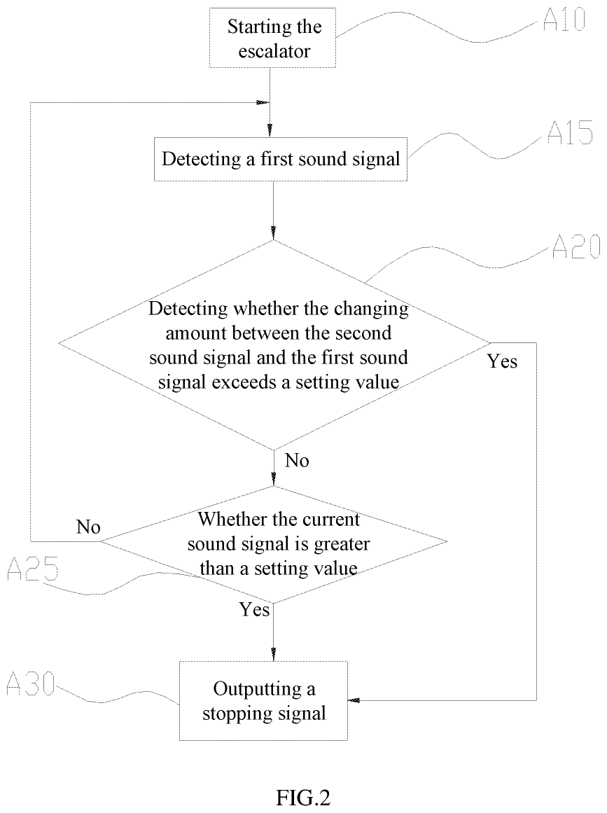

In other embodiments, refer to FIG. 2, and it could be determined whether a passenger on ladders has an accident by detecting the sound of the passengers on ladders by the sound pick-ups alone. The specific method is as follows:

Step A10: starting the escalator;

Step A15: detecting the sound made by the current passengers on ladders by the sound pick-ups and storing it as a first sound signal;

Step A20: detecting a second sound signal after a setting time interval, and if the changing amount between the second sound signal and the first sound signal exceeds a setting value, proceed to step A30; otherwise, proceed to the next step;

Specifically, the first sound signal and the second sound signal are relative concepts. In this embodiment, the time interval for detecting is 0.5 seconds. For example, a sound signal currently detected is the first sound signal, and a sound signal detected after 0.5 seconds is the second sound signal. Compare the two sound signals, and if the changing amount between the two sound signals is within the setting range, replace the original first sound signal with the second sound signal, and make a sound signal detected next time as a new second sound signal, so as to realize the real-time update of the sound signal, thereby more accurately detecting whether the changing amount of sound of the passengers on ladders exceeds the setting value. Besides, the preset changing amount of sound is 50%, and it is necessary to determine that the current passenger has an accident when the time that the changing amount of sound reaches more than 50% is more than twice, thereby outputting a stopping signal.

Step A25: proceeding to next step when the received current sound signal is greater than a setting value or when the waveform and a setting waveform reach the setting similarity; otherwise, proceeding to the step A15; wherein, the setting waveform refers to a signal set formed by waveform information of a sound wave signal for rescue made by a plurality of passengers on ladders;

Step A30: outputting a stopping signal.

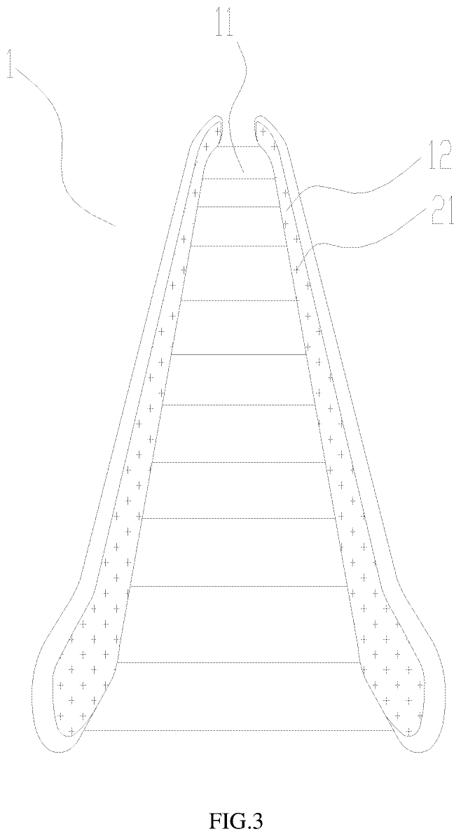

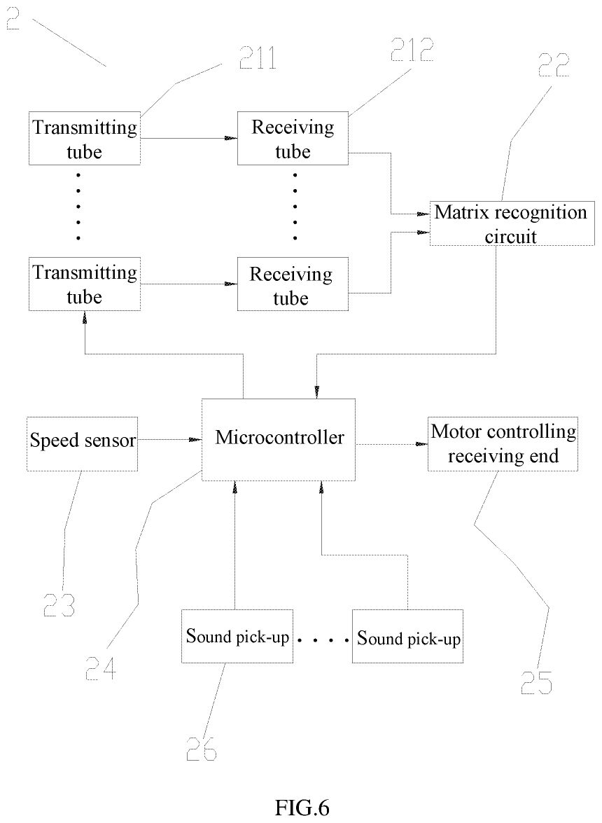

Referring to the embodiments illustrated in FIG. 3 and FIG. 6, a security detection device 2 for an escalator 1 of the present application, the escalator comprises a truss (not shown), and steps 11 slidably disposed on the truss and driven by a motor through a power mechanism, and both sides of the steps 11 are provided with guardrails 12. The security detection device 2 comprises a detecting circuit 21 disposed on the inner side of the guardrails 12 and for judging the passengers on ladders, and the detecting circuit 21 comprises a plurality of transmitting tubes 211 disposed on the inner side of the guardrail 12, and a plurality of receiving tubes 212 disposed on the inner side of the other guardrail 12, and the positions of the receiving tubes are one-to-one corresponding to the positions of the transmitting tubes 211; the security detection device 2 further comprises a microcontroller 24, and a matrix recognition circuit 22, a speed sensor 23, and a motor controlling receiving end 25 which are electrically connected to the microcontroller 24; the light of the transmitting tubes 211 is blocked by the passengers on ladders, and the receiving tubes 212 that have not received the light change to generate an electrical signal, and after being recognized by the matrix recognition circuit 22, the signal is combined to form an image signal which is saved in the microcontroller 24; and then divide a distance of the steps 11 in the moving direction by a movement speed of the steps 11 detected by the speed sensor 23, to get a detection interval time of the receiving tube 212; after the detection interval time, the microcontroller 24 receives a new image signal and compares it with the previous image signal, and when the difference between the two image signals exceeds the setting value, output a control signal to the motor controlling receiving end 25 to stop the motor, thereby stopping the moving of the steps 11.

Specifically, the transmitting tubes 211 are distributed in a matrix; the spacing between the two adjacent transmitting tubes 211 in the moving direction of the steps 11 is 50-100 mm, and the spacing between the two adjacent transmitting tubes 211 perpendicular to the moving direction of the steps 11 is 100-200 mm. The transmitting tube 211 is an infrared transmitting tube 211, and the receiving tube 212 is an infrared receiving tube 212.

Further, the security detection device 2 further comprises a mounting box for accommodating the microcontroller 24, and the mounting box is further provided with a control button electrically connected to the microcontroller 24, and the control button comprises a switch button and a self-learning button.

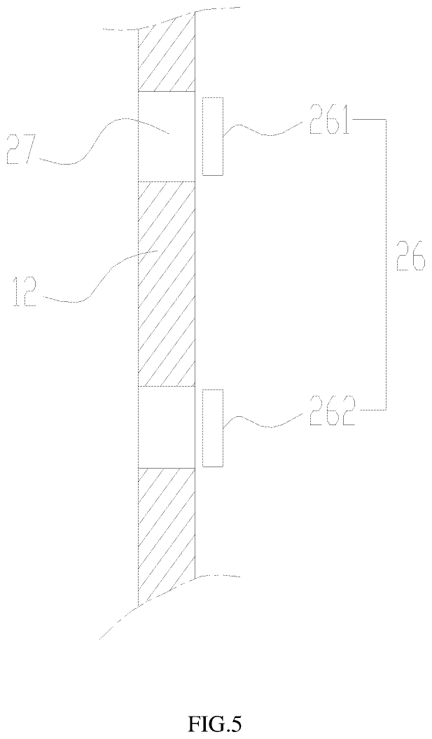

Refer to FIG. 5, the input end of the microcontroller 24 is electrically connected to at least one set of sound pick-ups 26, and each set of sound pick-ups 26 comprises a real-time sound pick-up 261 and a reference sound pick-up 262 which are installed at the same position, and the reference sound pick-up 262 is connected to the microcontroller 24 through an audio time delayer; the sound pick-ups 26 are disposed in the sound pick-up holes 27 disposed on the inner side of the guardrail 12 at intervals; wherein a sound signal collected by the reference sound pick-up 262 is transmitted to the microcontroller 24 through the audio time delayer, and is saved as a reference sound pick-up signal, and a real-time sound signal collected by the real-time sound pick-up 261 is transmitted to the microcontroller 24, and is compared with the reference sound pick-up signal, and when the changing amount exceeds the setting value, and the time that the changing amount exceeds the setting value continuously reaches the setting number of times, output the stopping signal. Preferably, the sound pick-up holes are arranged along the moving direction of the steps, and the distance between the two adjacent pick-ups is 1 m.

Specifically, the structure of the embodiment could be applied to the method embodiment shown in FIG. 2, wherein the first sound signal, that's the sound signal collected by the reference sound pick-up 262, is transmitted to the microcontroller 24 through the audio time delayer, and is saved as the reference sound pick-up signal, and the second sound signal is the real-time sound signal collected by the real-time sound pick-up 261.

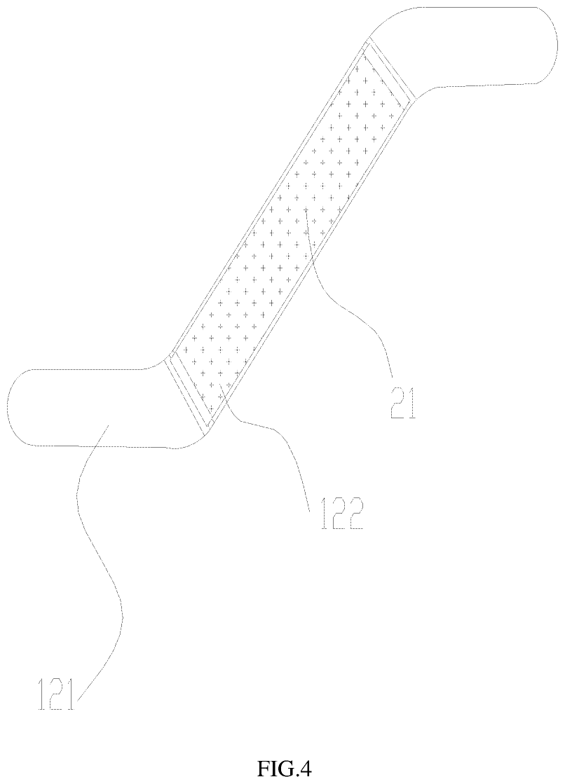

Referring to the embodiment shown in FIG. 4, the present embodiment is different from the previous embodiment in that: the guardrail 12 comprises two fixed guardrails 121 respectively disposed at the upper entrance and the lower entrance, and a movable guardrail 122 disposed between the two fixed guardrails 121, and the movable guardrail 122 is a reciprocating coaming plate that could be moved cyclically relative to the truss, and both ends of the movable guardrail 122 are provided with vertical rolling shafts, and the coaming plate is sleeved on the periphery of the rolling shaft, and performs cyclic reciprocating movement under the driving of the motor. The motor for driving the rolling shaft to rotate may be the same as the motor for driving the steps 11 to move, or may be an independent motor. The movement speed of the coaming plate is the same as the movement speed of the steps 11. When the passengers stand on the steps 11, they are stationary relative to the movable guardrail 122, which further ensures the security of the passengers on ladders.

In addition, gratings are arranged above the guardrail to remind the passengers on ladders not to extend out of the guardrail; the specific installation position and detection method of the gratings are as follows:

The gratings are respectively fixed on the outer sides of the two ends of the guardrail 12 of the escalator 1; the gratings are electrically connected to the microcontroller 24 and the buzzer. When the signal between the gratings is interrupted, determine that a certain part of the body of the current passengers on ladders is out the guardrail. At this time, the microcontroller 24 receives the interrupted signal of the grating, and then sends a command to the buzzer, and the buzzer sounds an alarm to remind the current passengers on ladders.

In conclusion, the inner side of the guardrail 12 of the security detection device 2 for the escalator 1 is provided with a detecting circuit 21 for judging the passengers on ladders, and when the difference of the image data detected at two different times exceeds the setting range, determine that the passengers on ladders has an accident, thereby stopping the operation of the escalator and ensuring the security of the passengers on ladders; in addition, the guardrail 12 is provided with a reciprocating coaming plate that could circularly move, and the movement speed of the coaming plate is the same as the movement speed of the steps 11, which could further improve the security of the escalator 1 and could better protect the security of the passengers on ladders.

The above content further describes the technical description of the present application by way of embodiments only for the easy understanding of readers, but it does not represent the embodiments are limited thereto, and any technology extension or re-creation according to the present application is subject to the protection of the present application. The protection scope of the present application is subject to the claims.

What is claimed is:

1. A security detection method for escalator, wherein, the escalator comprises a truss, and steps slidably disposed on the truss and driven by a motor through a power mechanism, and both sides of the steps are provided with guardrails, and the inner side of the guardrail is provided with a plurality of transmitting tubes, and a plurality of receiving tubes which are one-to-one corresponding to the transmitting tubes; the security detection method for the escalator comprises the following steps:
step S10: starting the escalator;
step S20: detecting a current image signal formed on the receiving tubes and caused by a blockage of a first current passengers, and saving it as a first image signal;
step S30: receiving a second image signal of a second current passengers after a detection interval time, and comparing the second image signal with the first image signal, and if the difference between the two image signals exceeds a setting value for image, proceeding to step S40, otherwise, replacing the first image signal with the second image signal, and proceeding to the step S20;
step S40: outputting a stopping signal;
wherein, the method further comprises the following step between the step S20 and the step S30:
step S25: detecting a sound made by passengers by sound pick-ups disposed in the guardrails, and if a received sound signal is greater than a setting value for sound, or a waveform of the sound signal and a setting waveform reach a setting similarity, proceeding to the step S40, otherwise, proceeding to the step S30; wherein the setting waveform refers to a signal set formed by waveform information of a sound wave signal for rescue made by a plurality of passengers.

2. The security detection method for escalator according to claim 1, wherein the method further comprises a step S15 between the step S10 and the step S20:
step S15: detecting whether a self-learning button is triggered, and if the self-learning button is triggered, proceeding to a self-learning step: when testers take the escalator, a generated image signal and a deformation value thereof are normal values, and calculating an average of signals generated by multiple testers, and saving it as the setting value for image, and repeating the step in a setting time period; if the self-learning button is not triggered, proceeding to the step S20.

3. A security detection method for escalator, wherein, the escalator comprises a truss, and steps slidably disposed on the truss and driven by a motor through a power mechanism, and both sides of the steps are provided with guardrails, and the inner side of the guardrail is provided with sound pick-ups for detecting a sound made by passengers; the security detection method for the escalator comprises the following steps:
step A10: starting the escalator;
Step A15: detecting a first sound made by a first current passengers by the sound pick-ups and storing it as a first sound signal;
step A20: detecting a second sound signal after a setting time interval, and if a changing amount between the second sound signal and the first sound signal exceeds a setting value, proceeding to step A30; otherwise, proceed to the next step;
step A25: proceeding to the next step when a received current sound signal is greater than a setting value or when a waveform of the sound signal and a setting waveform reach a setting similarity; otherwise, proceeding to the step A15; wherein the setting waveform refers to a signal set formed by waveform information of a sound wave signal for rescue made by a plurality of passengers;
step A30: outputting a stopping signal;
or,
the escalator comprises a truss, and steps slidably disposed on the truss and driven by a motor through a power mechanism, and both sides of the steps are provided with guardrails, and the inner side of the guardrail is provided with at least one set of sound pick-ups, and each set of sound pick-ups comprises a real-time sound pick-up and a reference sound pick-up which are installed at a same position, and the reference sound pick-up is connected to a microcontroller through an audio time delayer; the sound pick-ups are disposed in sound pick-up holes disposed on the inner side of the guardrail at intervals; a sound signal collected by the reference sound pick-up is transmitted to the microcontroller through the audio time delayer, and is saved as a reference sound pick-up signal, and a real-time sound signal collected by the real-time sound pick-up is transmitted to the microcontroller, and is compared with the reference sound pick-up signal, and when a changing amount between the real-time sound signal and the reference sound pick-up signal exceeds a setting value, and the time that the changing amount exceeds the setting value continuously reaches a setting number of times, output a stopping signal.

4. A security detection device for escalator, wherein the escalator comprises a truss, and steps slidably disposed on the truss and driven by a motor through a power mechanism, and both sides of the steps are provided with guardrails; and the security detection device comprises a detecting circuit disposed on the inner side of the guardrails and for judging passengers, and the detecting circuit comprises a plurality of transmitting tubes disposed on the inner side of the guardrail, and a plurality of receiving tubes disposed on the inner side of the other guardrail, and the positions of the receiving tubes are one-to-one corresponding to the positions of the transmitting tubes; the security detection device further comprises a microcontroller, and a matrix recognition circuit, a speed sensor, and a motor controlling receiving end which are electrically connected to the microcontroller; when the light of the transmitting tubes is blocked by the passengers, and the receiving tubes that have not received the light change to generate an electrical signal, and after being recognized by the matrix recognition circuit, the signal is combined to form an image signal which is saved in the microcontroller; and then divide a distance of the steps in the moving direction by a movement speed of the steps detected by the speed sensor, to get a detection interval time of the receiving tube; after the detection interval time, the microcontroller receives a new image signal and compares it with the previous image signal, and when the difference between the two image signals exceeds the setting value, output a control signal to the motor controlling receiving end to stop the motor, thereby stopping the moving of the steps; the security detection device further comprises a mounting box for accommodating the microcontroller, and the mounting box is further provided with a control button electrically connected to the microcontroller, and the control button comprises a switch button and a self-learning button.

5. The security detection device for escalator according to claim 4, wherein the transmitting tubes are distributed in a matrix; a spacing between two adjacent transmitting tubes in a moving direction of the steps is 50-100 mm, and a spacing between the two adjacent transmitting tubes perpendicular to the moving direction of the steps is 100-200 mm.

6. The security detection device for escalator according to claim 5, wherein the transmitting tube is an infrared transmitting tube, and the receiving tube is an infrared receiving tube.

7. The security detection device for escalator according to claim 4, wherein the guardrail comprises two fixed guardrails respectively disposed at an upper entrance and a lower entrance, and a movable guardrail disposed between the two fixed guardrails, and the movable guardrail is a reciprocating coaming plate that could be moved cyclically relative to the truss, and a movement speed of the coaming plate is the same as the movement speed of the steps.

8. The security detection device for escalator according to claim 7, wherein an input end of the microcontroller is electrically connected to at least one set of sound pick-ups, and each set of sound pick-ups comprises a real-time sound pick-up and a reference sound pick-up which are installed at a same position, and the reference sound pick-up is connected to the microcontroller through an audio time delayer; the sound pick-ups are disposed in the sound pick-up holes disposed on the inner side of the guardrail at intervals; gratings are arranged above the guardrail to remind passengers not to extend out of the guardrail; wherein a sound signal collected by the reference sound pick-up is transmitted to the microcontroller through the audio time delayer, and is saved as a reference sound pick-up signal, and a real-time sound signal collected by the real-time sound pick-up is transmitted to the microcontroller, and is compared with the reference sound pick-up signal, and when a changing amount between the real-time sound signal and the reference sound pick-up signal exceeds a setting value, and the time that the changing amount exceeds the setting value continuously reaches a setting number of times, output a stopping signal.
